(19) United States
(12) Patent Application Publication
(10) Pub. No.: US 2009/0096725 A1
(43) Pub. Date: Apr. 16, 2009

(54) ORGANIC ELECTROLUMINESCENT DISPLAY

(75) Inventors: Thierry Kretz, Saint Jean de Moirans (FR); Hugues Lebrun, Coublevie (FR); Elisabeth Chuiton, Revel (FR)

Correspondence Address: OBLON, SPIVAK, MCCLELLAND MAIER & NEUSTADT, P.C., 1940 DUKE STREET, ALEXANDRIA, VA, 22314, US

(73) Assignee: THALES, Neuilly Sur Seine (FR)

(21) Appl. No.: 12/298,140

(22) PCT Filed: Apr. 27, 2007
(86) PCT No.: PCT/EP2007/054148

§ 371 Date: Oct. 23, 2008

(30) Foreign Application Priority Data
Apr. 28, 2006 (FR) 0603863

(51) Int. Cl. G06F 3/038; G09G 3/32

(52) U.S. Cl. 345/82; 345/214

(57) ABSTRACT

In an organic light-emitting display screen, each picture dot includes an organic diode (OLED) and first and second current driver circuits for the diode. Each driver circuit includes: a driving transistor connected between a reference voltage and one electrode of the said diode, a switching transistor for switching a gate voltage onto the gate of the said driving transistor, and a capacitor connected to the gate of the said driving transistor, to maintain the gate voltage. The gate voltage of a driving transistor is alternately a video voltage controlling a display phase, or a turn-off voltage, controlling a recovery phase. The driving transistors are controlled alternately, one in recovery phase, the other in display phase, and vice versa.

The present invention relates to an organic light-emitting display screen and more particularly to an organic light-emitting display screen of the active matrix type, or AMOLED (Active Matrix Organic Light Emitting Diode).

In an organic light-emitting display screen, the picture element (pixel) is an organic light-emitting diode structure. Such a display screen does not require any additional light source, in contrast to other display devices such as the devices referred to as LCDs (Liquid Crystal Displays). Its other advantages include a low power consumption, a high brightness and low fabrication costs. The display of video data by OLED diodes is based on the principle of the modulation of the diode current. This is achieved by a current-driver transistor, which receives a voltage on its gate corresponding to the video data to be displayed and supplies a corresponding current to the diode.

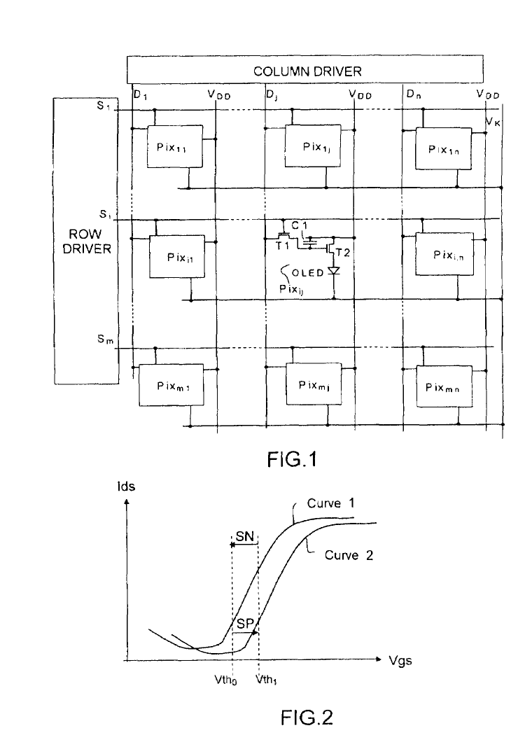

In FIG. 1 is shown an equivalent circuit diagram of an OLED picture dot or pixel according to the prior art. As illustrated in this Figure, the device usually comprises a crossed array of select lines S₁, S₂, . . . Sₘ, and data lines D₁, D₂, . . . Dₙ, m and n being integer numbers. To each pixel Pix_{i,j} of the matrix corresponds one select line Sᵢ, ∈[1, . . . m], and one data line Dⱼ, j∈[1, . . . n], by which this pixel is controlled. Each pixel Pix_{i,j} comprises an organic light-emitting diode or OLED and an associated current-driver circuit. This circuit comprises a switching transistor T1, a holding capacitor C1 and a current control, or “driving”, transistor T2. A gate electrode of the switching transistor T1 is connected to the corresponding select line Sᵢ and a conduction electrode, source or drain, connected to the associated data line Dⱼ. The other conduction electrode is connected to one terminal of the holding capacitor C1, and to the gate electrode of the driving transistor T2. The holding capacitor C1 has its other terminal connected to a reference voltage VDD. The driving transistor is connected in series with the organic light-emitting diode OLED between the reference voltage and ground: the anode of the diode is thus connected to a conduction electrode (drain or source) of the transistor T2 and its cathode is connected to a potential VK common to all the diodes of the display screen, typically the electrical ground. In the example, the transistors T1 and T2 are n-type.

In the usual manner, at each new video frame, the rows of pixels are selected in sequence by the application to their respective select line S₁, S₂, . . . Sₘ, of a selection voltage Vgon, lasting for a row time. The video data signals corresponding to a selected row of pixels are applied to the data lines D₁, . . . Dⱼ. These selection and data lines are controlled by respective driver circuits, called row driver and column driver, which may be integrated into the matrix or external to it. These circuits are well known to those skilled in the art.

The picture element Pix_{i,j} is now considered. When the select line Sᵢ is addressed, the switching transistor T1 turns on for the addressing time (row time) of the line. It switches the video voltage present on the data line Dⱼ onto the gate of the driving transistor T2. The transistor T1 then turns off and isolates the pixel from the data line. The capacitor C1 then ensures that the voltage on the gate of the transistor T2 is maintained. The transistor T2 operates as a controlled current source: it supplies to the OLED diode a current whose intensity depends on the video voltage switched onto its gate. The OLED diode emits a corresponding intensity of light. In this operation, the transistor T2 is continuously supplied with power: the duty cycle for the application of this voltage is therefore 100% for each video frame. The diode is also continuously driven, with a duty cycle of 100%.

The intensity of the current flowing in the driving transistor T2 depends on the level of the voltage switched onto the gate of the transistor T2. It also depends on the threshold voltage of this transistor. It is recalled that the threshold voltage of a transistor represents the minimum potential difference that must be applied between the gate and source of the transistor so that the latter allows current to flow: below this, the transistor is said to be turned off. The higher the potential difference, the more current the transistor allows to flow, until it becomes saturated. The drain-source current Ids is given by the following general equation: Ids=K(V_{gs}−Vₜₕ)², where Vₜₕ is the threshold voltage and V_{gs} the gate-source voltage.

In order to have a sufficient luminance and a good uniformity of the display screen, the current Ids corresponding to a given grey level must be constant over time whichever pixel of the display screen is considered.

The invention relates more particularly to AMOLED display screens, whose transistors of the active matrix (the transistors T1 and T2 of the pixels Pix_{i,j}) are thin-film transistors, referred to as TFTs, and notably to AMOLED display screens using an active matrix with amorphous silicon TFT transistors, which matrices are advantageously inexpensive. In these display screens, a significant positive drift of the threshold voltage of the driving transistor T2 is observed with the level of the voltage applied continuously to its gate (duty cycle of 100%). More generally, the threshold voltage of these transistors varies with temperature, the gate-source voltage applied to it and the duty cycle, in other words the time during which the voltage Vgs is applied with respect to the frame time. This also applies to other types of transistors, for example transistors using materials between amorphous silicon and polycrystalline silicon.

FIG. 2 illustrates a typical curve 1 of the drain-source current Ids as a function of the gate-source voltage Vgs of an amorphous silicon TFT transistor, under initial conditions, with a threshold voltage Vth₀. In the example, the transistor is an n-type transistor. Such a transistor has a positive or zero threshold voltage. It is made to conduct by applying a positive gate-source voltage, higher than its threshold voltage. After the transistor has been subjected to a positive stress SP, in other words to a gate-source voltage higher than the threshold voltage of the transistor, during one frame time (typically 20 milliseconds), a second curve 2 is obtained, which corresponds to a translation of the initial curve in the direction of increasing Vgs. This means that, owing to the positive stress, the threshold voltage of the transistor has increased, going from Vth₀ to Vth₁>Vth₀. The effect of this is that, for the same gate-source voltage, a lower current Ids will be driven in the transistor, and therefore the OLED diode will emit less light.

For a given data value to be displayed, the level of light obtained is therefore variable according to the effective threshold voltage of the transistor, at the time of observation. Since the threshold voltage has a positive drift, the current delivered by the driving transistors decreases, which results in a loss of luminance on AMOLED display screens.

Since the video voltages to be displayed vary from one pixel to another, this variation of the threshold voltage of the driving transistors T2 furthermore results in a significant non-uniformity over the AMOLED display screen.

One object of the invention is to solve this problem of degradation of the display on AMOLED display screens due to the drift of the threshold voltage of the driving transistors that control the organic light-emitting diodes.

One object of the invention is to provide a structure at minimal cost in terms of addressing control circuits.

One solution to this technical problem has been found in the invention which consists principally in providing a recovery phase for the drift of the threshold voltage of the driving transistor of each pixel. During this recovery phase, the driving transistor is turned off, by an appropriate value of voltage applied to its gate. The transistor is then subjected to a reverse stress to that it was subjected to during the display period, in such a manner that the threshold voltage returns to around its initial value Vth₀. Since the diode must be driven with a duty cycle of 100%, a first and a second driving transistor per diode are therefore provided, which are controlled in the appropriate manner such that, while one drives the current in the diode, the other is turned off, and vice versa. On average, for each transistor, the drift of the threshold voltage is zero.

The invention therefore relates to an organic light-emitting display screen comprising a crossed array of select lines and data lines in order to display successive video frame data on a plurality of picture dots by means of respective select and data lines, characterized in that each picture dot comprises an organic diode and first and second driver circuits for the said diode, each driver circuit comprising:
a driving transistor connected between a reference voltage and one electrode of the said diode,
a switching transistor for switching a gate voltage onto the gate of the said driving transistor,
a capacitor connected to the gate of the said driving transistor, in order to maintain the said gate voltage,
in that the said gate voltage of a driving transistor is alternately a video voltage, controlling a display phase, or a turn-off voltage, controlling a recovery phase, and in that the driving transistors are alternately controlled, one in recovery phase, the other in display phase, and vice versa.

The control of these circuits is optimized in such a manner that, in a matrix with n.m picture dots organized according to m rows and n columns, it uses as row select lines the only m row select lines of the matrix and/or as data lines the only n data lines of the matrix.

The turn-off voltage is preferably a function of the video voltage.

The invention also relates to a control circuit in a light-emitting display screen comprising: an organic diode and first and second driver circuits for the said diode, each driver circuit comprising:
a driving transistor connected between a reference voltage and one electrode of the said diode,
a switching transistor for switching a gate voltage onto the gate of the said driving transistor,
a capacitor connected to the gate of the said driving transistor, in order to maintain the said gate voltage, and
means for controlling the said first and second circuits, so as to apply, as gate voltage, a video voltage to one and a turn-off voltage to the other.
   In one variant, each of the said first and second driver circuits comprises another switching transistor connected between the gate of the switching transistor and the gate of the driving transistor.

The invention relates to several embodiments of the control of these driver circuits, using the select lines and/or data lines of the display screen.

Advantageously, use is made of the row drivers that control the select lines and/or the column drivers that control the data lines in liquid crystal display (LCD) screens in order to control these circuits in a suitable manner.

Other advantages and features of the invention are detailed in the following description with reference to the illustrated drawings of embodiments of the invention, presented by way of non-limiting example. In these drawings:

FIG. 1, already described above, illustrates the structure of an OLED diode picture element according to the prior art;

FIG. 2 illustrates the known phenomenon of drift of the threshold voltage of a transistor;

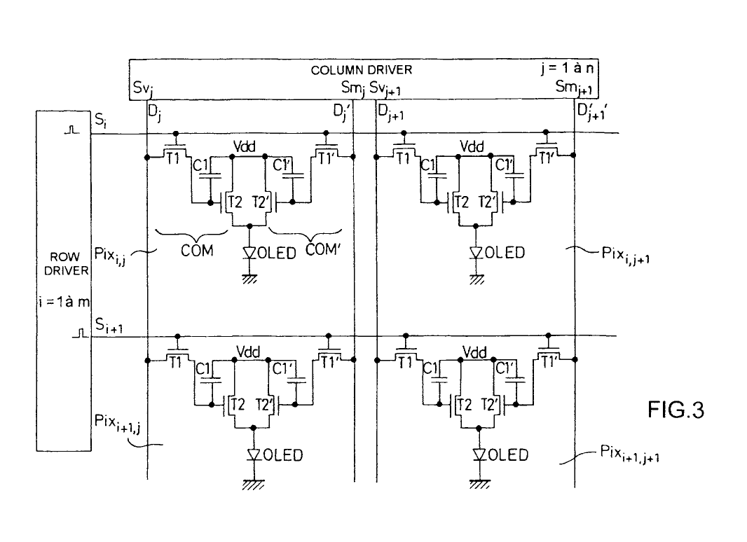

FIG. 3 illustrates an OLED diode picture element structure according to a first embodiment of the invention;

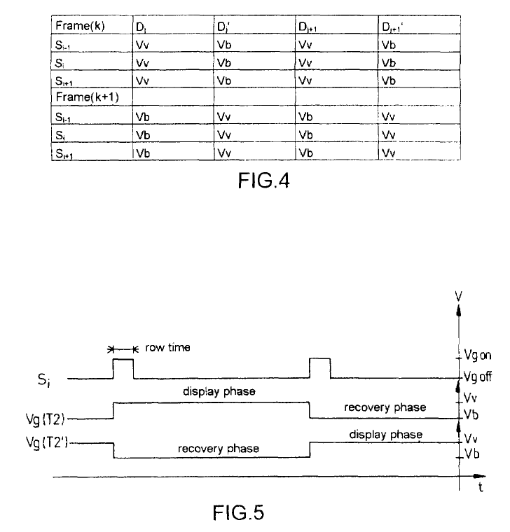

FIGS. 4 and 5 illustrate a corresponding addressing mode and addressing sequence;

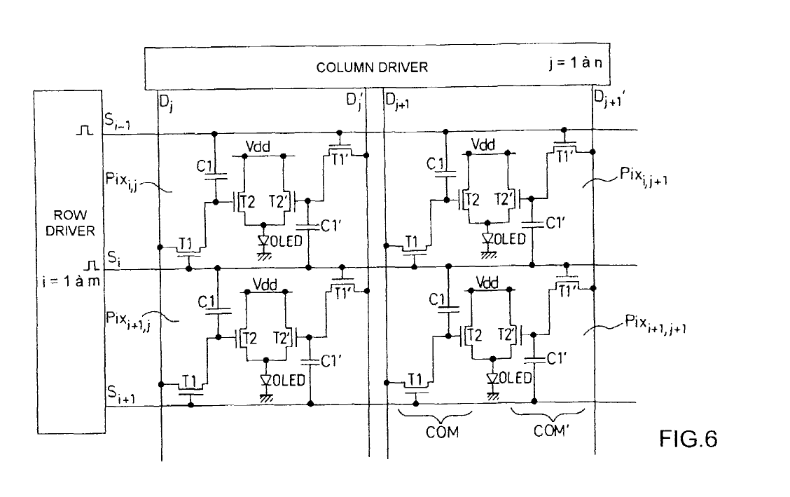

FIG. 6 illustrates an OLED diode picture element structure according to another embodiment of the invention; and

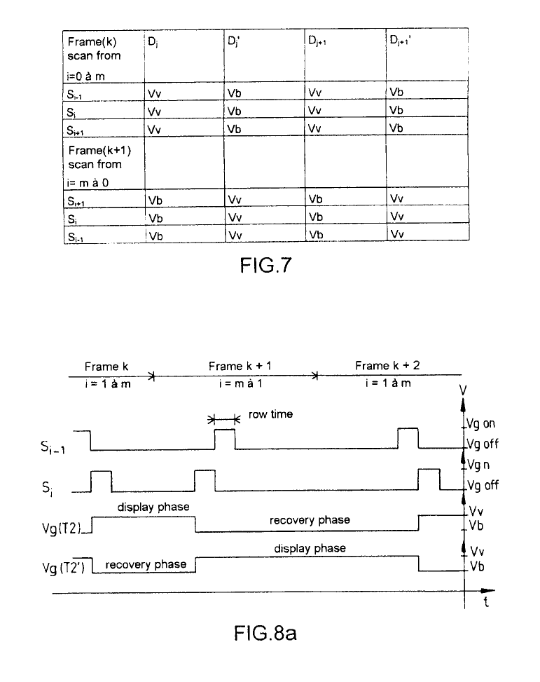

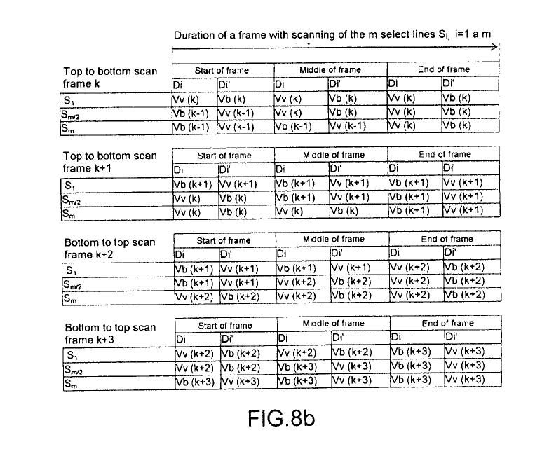

FIGS. 7, 8a and 8b illustrate a corresponding addressing mode and addressing sequences;

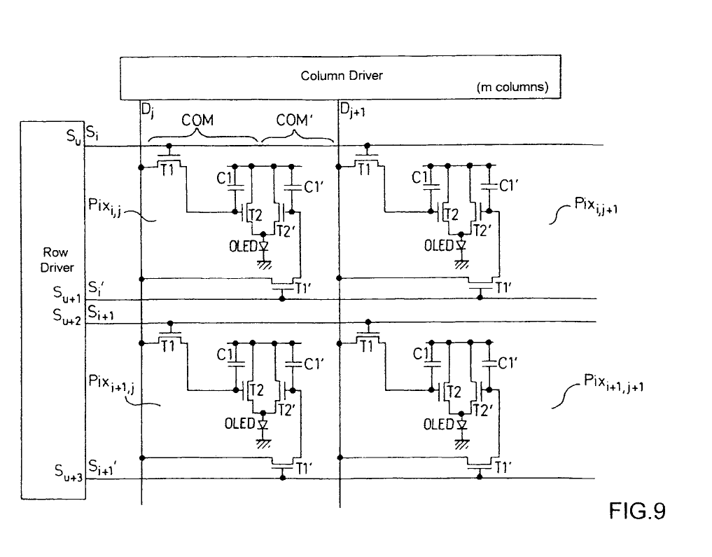

FIG. 9 illustrates an OLED diode picture element structure according to another embodiment of the invention;

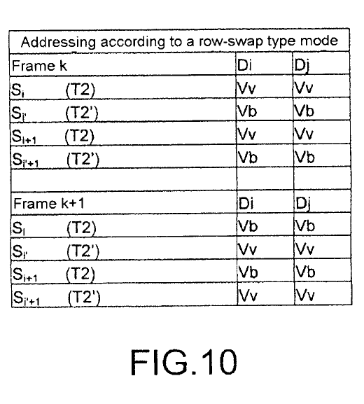

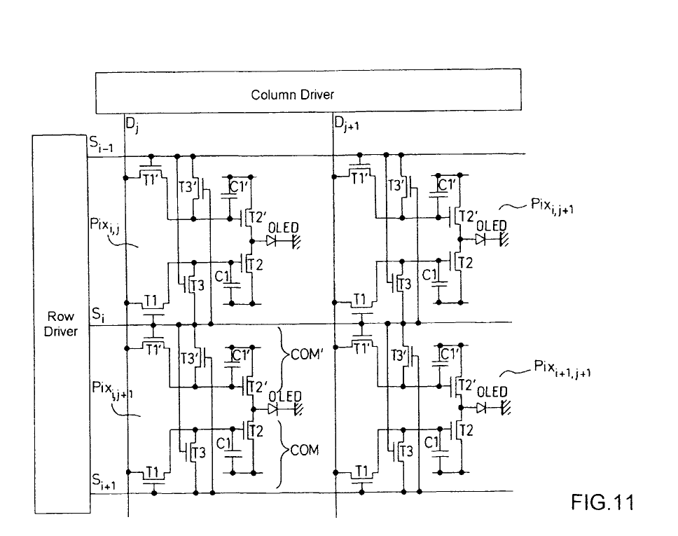

FIG. 10 illustrates a corresponding addressing mode;

FIG. 11 illustrates an OLED diode picture element structure according to another embodiment of the invention; and

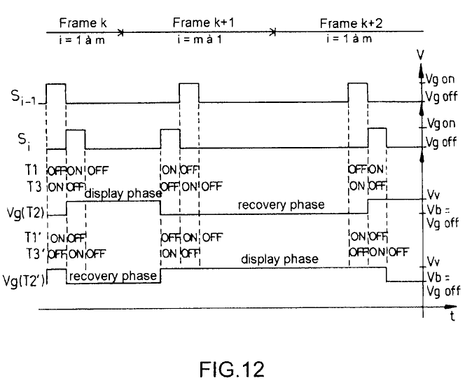

FIG. 12 illustrates a corresponding addressing sequence.

For the sake of clarity and simplicity of the description, the elements that are common to the various figures carry the same references. In the figures, the voltages applied to the gates of the transistors T2 and T2′ are denoted Vg(T2) and Vg(T2′).

According to the invention and as illustrated in FIGS. 3, 6, 9 and 11, each picture dot (or element) Pix_{i,j} of the organic light-emitting display screen comprises two driver circuits COM and COM′, of identical structure, associated with the organic light-emitting diode OLED of this dot Pix_{i,j}. The OLED diode comprises a first electrode E1 via which it is current driven, and a second electrode E2 (cathode) connected to a potential VK common to all the diodes of the screen. In the following, it is considered that this potential is electrical ground and is represented by a corresponding symbol.

The two driver circuits COM and COM′ are each connected at their outputs to the electrode E1 of the OLED diode. They have an identical structure. They each comprise a switching transistor, a driving transistor and a holding capacitor. By convention, these elements of the first circuit referenced COM are denoted as T1, C1 and T2, and these elements of the second circuit referenced COM′ as T1′, C1′ and T2′.

According to the invention, these circuits COM and COM′ are controlled by select and/or data lines of the matrix in such a manner that they have a different function at each video frame, these functions being reversed periodically. These functions are: 1.—display video information, by application of a video voltage to the gate of the driving transistor, in order to deliver a corresponding current to the OLED diode and 2.—compensate for the stress caused by the first function, by recovery phases during which a turn-off voltage is applied to the gate of the driving transistor.

Thus, during a given video frame, one of the two circuits, for example the circuit COM, has the function of displaying the video information via the OLED diode, by applying a corresponding video voltage to the gate of its transistor T2, whereas the other circuit, in the example COM′, has the function of applying a turn-off voltage to the gate of its transistor T2′, which puts this transistor into the phase for recovery of the drift in threshold voltage, according to the invention. The functions of the two circuits are reversed periodically: the circuit COM′ then has the function of displaying the video information, by applying a corresponding video voltage to its transistor T2′, whereas the circuit COM has the function of compensating for the stress undergone by its transistor T2, by applying a turn-off voltage to it.

Since, on average, one out of every two frames is used for each driver circuit in order to de-stress its driving transistor, the average drift of the threshold voltage of each driving transistor of the active matrix is zero or approximately so. This can be achieved without affecting the duty cycle for the application of the video voltage to the OLED diode, so that the diode remains continuously driven (duty cycle of 100%).

The reversing period of the functions of the driver circuits is preferably the frame period: at each new video frame, the functions of the circuits are reversed. More generally, a reversing of the functions may be envisaged every K frames, K being any integer number. It will be seen that a corresponding addressing mode of the circuits COM and COM′ may be easily implemented by using commercially available row and column drivers.

The turn-off voltage of the recovery phase can be a pre-determined fixed voltage. It is advantageously variable. For each picture dot, it is advantageously a function of the video voltage applied to the picture dot. Indeed, the video voltage applied varies from one picture element of the display screen to another. For a given pixel, the video voltage also varies with time, from one frame to another. The drift of the threshold voltages is therefore variable from one pixel to another. For this reason, by fixing the turn-off voltage, an image with a non-uniform luminance is obtained, in spite of the recovery phase. By advantageously arranging for the turn-off voltage to be such that it applies a stress amplitude to the driving transistor that is the inverse of the video voltage, an intelligent recovery of the drift of the threshold voltage is implemented.

The embodiment according to the invention illustrated in FIG. 3 is now considered. The display screen comprises n.m pixels Pix_{i,j}, i=1 to m; j=1 to n. It comprises m select lines Sᵢ, each line allowing n pixels of the display screen to be addressed. It comprises 2.n data lines Dⱼ and Dⱼ′, which allow a video voltage and a turn-off voltage to be applied to each of the n pixels of one select line.

More precisely, to each picture element Pix_{i,j} corresponds one select line Sᵢ to which are connected the gates of the switching transistors T1 and T1′, a first data line Dⱼ and a second data line Dⱼ′. The first data line Dⱼ is connected to the switching transistor of one of the driver circuits, and the second data line Dⱼ′ is connected to the switching transistor of the other driver circuit. Thus, in the example, Dⱼ is connected to the switching transistor T1 of the circuit COM and Dⱼ′ is connected to the switching transistor T1′ of the circuit COM′.

As illustrated in FIG. 4, during a given video frame k, the data line Dⱼ will deliver the video voltage Vv and the data line Dⱼ′ will deliver the turn-off voltage Vb. It is the driving transistor T2 that will then deliver the current to the OLED diode, whereas the transistor T2′ will be in the recovery phase.

During another video frame, for example the following frame k+1, the reverse will occur: the line Dⱼ will deliver the turn-off voltage Vb and the data line Dⱼ′ will deliver the video voltage Vv. It is then the driving transistor T2′ that will deliver the current to the OLED diode, whereas the transistor T2 will be in the recovery phase.

An example of corresponding addressing sequence is illustrated schematically in FIG. 5, which demonstrates the dual behaviour of the transistors T2 and T2′: when one is in the display phase, the other is in the recovery phase and vice versa.

It has been seen that the turn-off voltage Vb applied to a pixel is a pre-determined fixed voltage or, advantageously, a voltage that is variable from one pixel to another, being a function of the video voltage applied to the pixel.

A column driver normally used in liquid crystal displays (LCDs) may advantageously be used as column driver for controlling the 2n data lines of a display screen according to the embodiment in FIG. 3. Indeed, these drivers are designed to supply a voltage, referred to as mirror voltage, that is a function of the applied video voltage. More precisely, they usually deliver at the output, for a given row of pixels, the video voltage to be applied to each data line Dⱼ of the matrix, which is a function of the video signal DATA VIDEO received at the input, or a corresponding mirror voltage. It is recalled that the picture dot of an LCD screen is a liquid crystal cell with one pixel electrode, to which the video voltage is applied, and a counter-electrode common to all the pixels, to which a reference voltage is applied. The mirror voltage of a given video voltage is such that the direction of the electric field across the terminals of the pixel is reversed, but allows the same luminance to be obtained (the same grey level). The column drivers of LCD screens thus usually deliver at the output, for each data line of the matrix, one or the other voltage, according to the frame (reversed frame mode), and/or according to the pixel column (reversed column mode), concerned. In a reversed column mode, the following operation will thus occur: on one frame, the video voltage is applied to the data lines Dⱼ, Dⱼ₊₂, Dⱼ₊₄; and the mirror voltage to the data lines Dⱼ₊₁, Dⱼ₊₃, Dⱼ₊₅. On the following frame, the reverse occurs: the mirror voltage is applied to the data lines Dⱼ, Dⱼ₊₂, Dⱼ₊₄; and the video voltage is applied to the data lines Dⱼ₊₁, Dⱼ₊₃, Dⱼ₊₅ and so on. In a known manner, this prevents the phenomenon known as ‘marking’ from occurring, by alternating the direction of the electric field on the pixels, and allows the power consumption to be reduced.

The mirror voltage is defined with respect to the counter-electrode voltage in order to obtain the same transmission coefficient on the pixel as with the video voltage. Generally speaking, the video voltage is taken to be positive and the mirror voltage to be negative.

Thus, the mirror voltage has an amplitude that is the corresponding inverse of the video voltage: this definition applies very well to the notion of variable turn-off voltage that is a function of the video voltage: a stress in voltage, of inverse amplitude, is applied that is negative with respect to the voltage stress caused by the video voltage that drives the current conduction. The value of this inverse amplitude is, in practice, determined by measurement, in such a manner as to compensate, in an optimal manner, for the stress caused by the video voltage.

The turn-off voltage to be applied in order to compensate for a video voltage of given amplitude may be determined by suitable measurements. A correspondence table, applicable to a given display screen, can thus be defined. It will then suffice to use appropriate values of resistors in the potential divider circuit that normally delivers the corresponding video voltage and mirror voltage levels.

Such an LCD screen column driver can thus be used to control the data lines of a display screen such as is illustrated in FIG. 3: it suffices to output, for each pixel column j, the two outputs video voltage Svⱼ and mirror voltage Smⱼ, and for these two outputs to be connected, the first to the data line Dⱼ and the second to the data line Dⱼ′, and to control this column driver in reversed column mode (FIG. 4): on one frame k the column driver applies the video voltage to the data lines Dⱼ and the mirror voltage, i.e. the turn-off voltage, to the data lines Dⱼ′; on the following frame, the reverse occurs: the column driver applies the mirror voltage, i.e. turn-off voltage, to the data lines Dⱼ, and the video voltage to the data lines Dⱼ′, and so on, for example from frame to frame.

FIG. 6 illustrates another embodiment of the invention. As in the embodiment illustrated in FIG. 3, the display screen comprises n.m pixels Pix_{i,j}, i=1 to m; j=1 to n. It comprises m select lines Sᵢ, each line allowing n pixels of the display screen to be addressed. It comprises 2.n data lines Dⱼ and Dⱼ′, which allow a video voltage and a turn-off voltage to be applied to each of the n pixels of a select line. It differs from the previous embodiment, seen in relation to FIG. 3a, in that the control of the two driver circuits COM and COM′ uses, at the same time, two select lines of the display screen Sᵢ and Sᵢ₋₁, and two data lines Dⱼ and Dⱼ′.

This embodiment corresponds to an addressing mode for the matrix known as ‘inverted vertical scanning’: during one frame, the select lines are sequentially addressed from top to bottom, and in the following frame they are sequentially addressed from bottom to top.

Looking in more detail, in this embodiment of the invention, to each picture element Pix_{i,j} are made to correspond the select line Sᵢ to which the gate of the switching transistor of one of the driver circuits is connected, and another select line of the matrix, preferably the preceding select line Sᵢ₋₁, to which the gate of the switching transistor of the other driver circuit is connected. To each pixel Pix_{i,j}, a first data line Dⱼ and a second data line Dⱼ′ are also made to correspond. The first data line Dⱼ is connected to the switching transistor of one of the driver circuits, and the second data line Dⱼ′ is connected to the switching transistor of the other driver circuit. Thus, in the example, the gate of the switching transistor T1 of the circuit COM is connected to Sᵢ, the gate of the switching transistor T1′ of the circuit COM′ is connected to Sᵢ₋₁; Dᵢ is connected to the switching transistor T1 of the circuit COM and Dⱼ′ is connected to the switching transistor T1′ of the circuit COM′.

The example illustrates a connection variant of the holding capacitor of the driver circuits COM and COM′: the holding capacitor of one of the driver circuits is connected to the select line that controls the gate of the switching transistor of the other driver circuit. Thus, the holding capacitor C1 of the driver circuit COM is connected to the select line Sᵢ₋₁, which is connected to the gate of the transistor T1′ of the driver circuit COM′. The holding capacitor C1′ of the driver circuit COM′ is connected to the select line Sᵢ which is connected to the gate of the transistor T1 of the driver circuit COM. As previously, the capacitors C1 and C1′ could be connected to the reference voltage Vdd.

The mode of operation will then be as follows:

During one video frame, the frame k for example, the select lines are scanned in sequence from top to bottom, in other words in the direction of increasing indices i from 1 to m (FIG. 1). In this case and as indicated in FIG. 7, the data lines Dⱼ are controlled in order to transmit the video voltages and the data lines Dⱼ′ are controlled in order to transmit the turn-off voltages.

When the select line Sᵢ₋₁ is addressed, by applying a voltage level Vgon during a corresponding row time, the switching transistor T1′ of the circuit COM′ is conducting. It switches the turn-off voltage present at that time on the column Dⱼ′ onto the gate of the transistor T2′: the transistor T2′ enters the recovery phase.
When the select line Sᵢ is addressed at the following row time, by applying during the corresponding row time, the voltage level Vgon, the switching transistor T1 of the circuit COM is conducting. It switches the video voltage present at that time on the column Dⱼ onto the gate of the transistor T2: the transistor T2 enters the display phase, and delivers the current to the OLED diode.

During the following frame k+1, the select lines are scanned in sequence in the reverse order, in other words from the bottom to the top or, alternatively, in the order of decreasing indices i from m to 1 (FIG. 1) and the role of the data lines Dⱼ and Dⱼ′ is reversed: the lines Dⱼ transmit the turn-off voltages and the lines Dⱼ′ transmit the video voltages (FIG. 7). When the select line Sᵢ is addressed, by applying for a corresponding row time a voltage level Vgon, the switching transistor T1 of the circuit COM is conducting. It switches the turn-off voltage present on the data line Dⱼ, onto the gate of the transistor T2 and the associated holding capacitor C1. The transistor T2 is in the recovery phase.

When the select line Sᵢ₋₁, is then addressed, by applying for a corresponding row time a voltage level Vgon, the switching transistor T1′ of the circuit COM′ is conducting. It switches the video voltage present on the data line Dⱼ′, onto the gate of the transistor T2′ and the associated holding capacitor C1′. During this frame k+1, it is the transistor T2′ that is in the display phase and the transistor T2 that is in the recovery phase.

A corresponding addressing sequence is illustrated in FIG. 8a. It demonstrates that the respective durations of display phase and recovery phase are not equal for the two transistors T2 and T2′ of a pixel, owing to the alternation of the vertical scanning. In the example illustrated, the recovery phase of the transistor T2 is longer than its display phase. For the transistor T2′, the reverse is true. In practice, the durations of the display and recovery phases of the transistors T2 and T2′ of a pixel Pix_{i,j} depend on the rank i of the corresponding select line Sᵢ. In practice, a delay time is included between the end of the scanning of the lines of one frame and the start of the scanning of the lines of the following frame.

In order to converge towards close, or even equal, durations between top-bottom and bottom-top scanning:
the matrix can be addressed rapidly then a delay time be left before the following scan;
scanning X times always in the same direction can be effected before switching to a scan of X times in the other direction. The table in FIG. 8b is an illustration that with such an alternation of the scanning every X=2 frames, the recovery and video times between COM and COM′ can be balanced. In this Figure, Vv(k) and Vb(k) represent the video and turn-off voltages switched onto the gates of the transistors T2 and T2′ of the pixels for the select line in question applied during the frame k. As long as the select line in question has not been selected, the voltage levels of the gates of the transistors T2 and T2′ are those applied on the preceding frame k−1. In the table, the variation of the voltage levels over the frame time, and for four successive frames, is shown for a line at the top of the display screen, in the example S₁, from the middle of the display screen (S_{m/2}) and from the bottom of the display screen (Sₘ).

The turn-off voltage may be fixed or a function of the video voltage. In the latter case, and as in the embodiment seen in relation to FIG. 3, a column driver from the prior art of LCD screens may advantageously be employed for addressing the data lines of a display screen according to FIG. 6. The driver will then be used to control the data lines Dⱼ, Dⱼ′ as described in the previous embodiment, with in addition the reversing of the presentation of the video data in the direction of scanning of the select lines Sᵢ. For example, in one frame, the column driver applies the video voltage to the data lines Dⱼ, and the mirror, or turn-off, voltage to the data lines Dⱼ′, in the successive order of the lines Sᵢ scanned from top to bottom. In the following frame, the reverse occurs: the column driver applies the mirror, or turn-off, voltage to the data lines Dⱼ′, and the video voltage to the data lines Dⱼ, in the successive order of the lines Sᵢ scanned from bottom to top, and so on from frame to frame.

It will be noted that the embodiment in FIG. 6, in which the holding capacitors are connected between the gate of a driving transistor and a select line, combined with the progressive alternation of the scanning of the select lines, allows undesirable coupling phenomena via C1 or C1′ to be prevented.

In the embodiments in FIGS. 3 and 6, the driver circuits COM and COM′ are identical to the circuit of the prior art (FIG. 1), the alternating control of their driving transistors T2 and T2′ being obtained by the select and data lines that control their switching transistors T1 and T1′, by doubling the number of data lines to be controlled.

In one variant illustrated in FIGS. 9 and 10, instead of using the data lines in order to allow the alternation of the display and recovery functions of the driver circuits COM and COM′, the select lines are used: instead of doubling the number of data lines, the number of select lines is doubled.

As illustrated in FIG. 9, there are then 2.m select lines, two per pixel, and n data lines associated with the n.m pixels Pix_{i,j} of the display screen, and the matrix is addressed in a row-swap mode: the video voltage is applied to the even rows and the turn-off voltage is applied to the odd rows (recovery phase) and everything is swapped in the following frame.

One advantage of transferring to the row driver the control of the alternation of the display and recovery functions of the driver circuits COM and COM′ resides in the fact that the row drivers are less costly than the column drivers in terms of complexity and space. Moreover, these drivers can be easily integrated onto glass, and notably in amorphous silicon technology.

In this embodiment, the gate of the switching transistor of a driver circuit is connected to the select line of the pixel Pix_{i,j}, and the gate of the switching transistor of the other driver circuit is connected to another select line that is denoted Sᵢ′. The lines Sᵢ and Sᵢ′ are two successive rows of the row driver Sᵤ and Sᵤ₊₁, with u=1 to 2m, and i=1 to n.

The addressing of the matrix can be related to an addressing of the row-swap type for the LCD with the select lines Sᵢ addressing the video and the lines Sᵢ′ addressing the recovery and vice versa in the following frame.

A corresponding addressing mode for the matrix is illustrated in the table in FIG. 10, which demonstrates the dual behaviour of the transistors T2 and T2′, in relation to FIG. 9.

The pixel Pix_{i,j} is now considered.

During a frame k, when the row Sᵤ=Sᵢ is addressed, the transistor T1 is conducting and switches the video voltage Vv present at this time on the data line Dⱼ onto the gate of the transistor T2 and the capacitor C1.

When the row Sᵤ₊₁=Sᵢ′ is addressed, the transistor T1′ is conducting and switches the video voltage Vb present at this time on the data line Dⱼ onto the gate of the transistor T2′ and the capacitor C1′.

With regard to the control of the column driver, the video/recovery alternation for the driver circuits of a given pixel is performed on the same column: there is a time for displaying the video voltage and a time for applying the recovery voltage. Since the number of rows has doubled (u=2.m), the row time is divided by 2.
The turn-off voltage can be the video voltage, inverse of the video that was applied in the preceding frame (column driver output) or else a pre-determined reset voltage. This reset voltage can then for example be applied to the columns by multiplexing, by using an integrated column driver circuit design with 3 TFT transistors, such as that described in the application EP0815552: either the driver output is applied to the columns or the reset voltage.

Another embodiment of the invention is illustrated in FIG. 11. This embodiment has the advantage, with respect to the two embodiments previously described, of using only the usual select and data lines of the display screen. For a display screen of n.m pixels, there are therefore m select lines Sᵢ and n data lines Dⱼ as in the prior art (FIG. 1). In other words, it does not require the data lines to be doubled, in contrast to the embodiments illustrated in FIGS. 3, 6 and 9. This is a valuable advantage in terms of circuit topology (line crossing, control of the lines) and space occupied.

This is obtained by providing in the driver circuit an additional switching transistor by which the alternating control of the driving transistors will be provided. This additional transistor of the driver circuit is denoted T3 for the circuit COM and T3′ for the circuit COM′.

Looking in more detail, in this embodiment of the invention, to each picture element Pix_{i,j} are made to correspond a single data line Dⱼ that is connected to the switching transistors T1 and T1′ of the two driver circuits COM and COM′, a first select line Sᵢ to which the gate of the switching transistor of one of the driver circuits is connected, and another select line of the matrix, preferably the preceding line Sᵢ₋₁, to which the gate of the switching transistor of the other driver circuit is connected. In the example, Sᵢ is connected to the gate of the switching transistor T1 of the circuit COM, and S_{i-31 1} is connected to the gate of the switching transistor T1′ of the circuit COM′. The elements T1, C1 and T2 of the circuit COM and T1′, C1′ and T2′ of the circuit COM′ are connected together and to the diode, as before (FIGS. 1, 3, 6).

The additional switching transistor provided in each driver circuit is connected between the gate of the driving transistor and the gate of the switching transistor. The gate of this additional transistor is connected to the select line associated with the other driver circuit. Thus, in the example illustrated, the driver circuit COM comprises an additional transistor T3, connected between the gate of the switching transistor T1 and the gate of the driving transistor T2. This additional transistor has its gate connected to the select line Sᵢ₋₁. In a similar manner, the driver circuit COM′ comprises an additional transistor T3′, connected between the gate of the switching transistor T1′ and the gate of the driving transistor T2′. This additional transistor has its gate connected to the select line Sᵢ.

In the figure, the holding capacitor in each driver circuit is connected to the reference voltage VDD. The holding capacitor could also just as well be connected as in FIG. 6.

The switching transistors T3 and T3′ in each driver circuit allow the alternate turning off of the driving transistors to be obtained, by switching of the voltage level Vgoff of the unaddressed select lines. Indeed, each select line is forced to a level Vgoff, whenever it is not addressed. This level Vgoff is such that the switching transistor is turned off. When it is addressed, it has a voltage level Vgon applied to it for a row time, in such a manner that the switching transistors connected to this line go to the “on” state and switch the voltage present on the data line onto the gate of the driving transistor. In the example illustrated, the transistors T1, T2, T3, T1′, T2′, T3′ are all of the same type, n-type in the example, in order to be switched to the on state by a level Vgon on their gate and to the off state by a level Vgoff on their gate.

One example of corresponding addressing sequence is illustrated schematically in FIG. 12, which demonstrates the dual behaviour of the transistors T2 and T2′.

This embodiment uses a reversed vertical scanning addressing mode in order to provide the dual control, in an alternating fashion, of the two driven circuits.

In this embodiment, the level Vgoff is therefore used as turn-off voltage for the driving transistors, which is switched in a suitable manner by the additional transistors T3.

The operation is then as follows:

During the frame k, the display screen is scanned from top to bottom.

When the select line Sᵢ₋₁, is addressed, the transistors T1′ and T3 are switched to the “on” state for the corresponding row time. The select line Sᵢ is not addressed at this time, and is at the level Vgoff. The transistors T1 and T3′ are in the “off” state.
The transistor T1′ switches the video voltage present at this time on the data line Dⱼ onto the gate of the driving transistor T2′: the transistor T2′ delivers the current needed for driving the diode. The transistor T3 switches the level Vgoff present on the line Sᵢ onto the gate of the driving transistor T2, which turns this transistor T2 off, putting it into recovery phase.
Then, the select line Sᵢ₋₁ is deselected, brought back to the voltage level Vgoff and the select line Sᵢ is addressed, with the voltage level Vgon being applied to it for the corresponding row time. The transistors T1 and T3′ are switched to the conducting or “on” state. The transistors T1′ and T3 go to the “off” state. The transistor T1 switches the video voltage present at that time on the data line Dᵢ onto the gate of the driving transistor T2. The transistor T3′ switches the voltage level Vgoff present at that time on the select line Sᵢ₋₁ onto the gate of the switching transistor T2′, which is then turned off and put into the recovery phase.
Thus, the transistor T2, after having been turned off and in recovery phase during the preceding row time (addressing of the select line Sᵢ₋₁), supplies the current corresponding to the applied video voltage to the OLED diode for the whole of the rest of the frame.

During the following frame k+1, the scan order of the display screen is reversed, the line Sᵢ thus being addressed before the line Sᵢ₋₁. The roles of the various transistors of the pixel Pix_{i,j} are reversed.

When the select line Sᵢ is addressed, the transistors T1 and T3′ are conducting or “on”. At this time, the select line Sᵢ₋₁, which is not addressed, is at a voltage level Vgoff. The transistors T1′ and T3 are therefore turned off. The transistor T1 switches the video voltage present at that time on the data line Dⱼ onto the gate of the driving transistor T2. The transistor T2 supplies the current to the OLED diode. The transistor T3′ switches the level Vgoff onto the gate of the driving transistor T2′, turning this transistor off, into the recovery phase.
When the select line Sᵢ₋₁, is subsequently addressed, the transistors T1′ and T3 are turned on. The select line Sᵢ, which is no longer addressed, is at a level Vgoff. The transistors T1 and T3′ are turned off.
The transistor T1′ switches the video voltage present at that time on the data line Dⱼ onto the gate of the driving transistor T2′, which turns on and drives the current into the OLED diode. The transistor T3 switches the level Vgoff onto the gate of the transistor T2, which turns this transistor off, into the recovery phase.
Thus, the transistor T2′ after having been turned off and in recovery phase during the preceding row time (addressing of the select line Sᵢ), then supplies the current corresponding to the applied video voltage to the OLED diode for the whole of the rest of the frame. While the transistor T2′ is turned off, it is the transistor T2 that supplies the current to the OLED diode.

Variant embodiments may be envisaged. For example, the gate and the drain of the additional transistors T3 and T3′ can be connected to the select lines according to different arrangements. The important thing is to obtain the switch command for Vgoff at the right moment. Considering the pixels of the select line Sᵢ, the gate of the transistors T3 can, for example, be connected to the preceding select line Sᵢ₋₁, and the drain to the present select line Sᵢ, and the gate of the transistors T3′ to the preceding select line Sᵢ₊₁, and the drain to the select line Sᵢ.

As in the embodiment explained in relation to FIG. 6, the durations of the display and recovery phases are not equal for the two transistors T2 and T2′. These durations can be made to converge by applying the same principles explained on page 12, line 26 and following lines.

In the embodiments that have just been described by way of examples of the implementation of the invention, or in variants of these embodiments that follow from them, and in particular in the embodiments seen in relation to FIGS. 3, 4 and 6, the column drivers normally used in liquid crystal display screens (LCDS) will be advantageously employed, which drivers thus advantageously deliver a variable turn-off voltage, being a function of the video voltage, and whose various addressing modes (row-swap, column-reversing, dot reversing, frame reversing) allow the diode to be driven with a duty cycle of 100%, while at the same time providing the alternation of the display and recovery phases on the driving transistors.

Those skilled in the art know how to use these various addressing modes in the appropriate manner with an organic light-emitting display screen according to the invention, by using the mirror voltage outputs of the driver as turn-off voltage outputs for the driving transistors, so as to achieve the operation sought, with the video voltage/turn-off voltage alternation on each of the various driving transistors of the display screen. The turn-off voltage is then a function of the applied video voltage.

The invention just described is especially applicable to organic light-emitting display screens that use an active matrix with TFT transistors (amorphous silicon). It is more generally applicable to active matrix organic light-emitting display screens.

1-7. (canceled)

8. An organic light-emitting display screen comprising:
n·m picture dots organized in a matrix with m rows and n columns, each picture dot comprising an organic diode and first and second driver circuits for the diode, each comprising:
a driving transistor connected between a reference voltage and one electrode of the said diode,
a switching transistor for switching a gate voltage onto the gate of the driving transistor,
a capacitor connected to the gate of the driving transistor, to maintain the gate voltage;
wherein a circuit for addressing the n·m picture dots, to control alternately and simultaneously a recovery phase on one driver circuit and a display phase on the other driver circuit of a picture dot, comprises as row select lines, only m row select lines, one per row of picture dots, and/or as data lines, only n data lines, one per column of picture dots.

9. A display screen according to claim 8, wherein the addressing circuit comprises only the m row select lines, and 2·n data lines, two lines per picture dot column, and to each picture element are made to correspond a respective select line connected to the gates of the switching transistors of the associated first and second driver circuits, a first data line connected to the switching transistor of one of the two driver circuits and a second data line connected to the switching transistor of the other of the two driver circuits, and wherein during one video frame, one of the first and second data lines delivers a video voltage and the other a turn-off voltage, and during another video frame, the reverse occurs.

10. A display screen according to claim 8, wherein the addressing circuit comprises only the m row select lines, and 2·n data lines, two lines per column of picture dots, and to each picture element are made to correspond a first select line and a second select line, the first being connected to the gate of the switching transistor of one of the two driver circuits, the second being connected to the gate of the switching transistor of the other driver circuit, a first data line being connected to the switching transistor of one of the two driver circuits and a second data line being connected to the switching transistor of the other driver circuit, and wherein during one video frame, one of the first and second data lines delivers a video voltage, and the other a turn-off voltage, and during another video frame, the reverse occurs.

11. A display screen according to claim 8, wherein the addressing circuit comprises only the m row select lines and n data lines, and to each picture element are made to correspond a respective data line connected to the switching transistors of the two associated driver circuits, and a first select line and a second select line, the first being connected to the gate of the switching transistor of one of the two driver circuits, the second being connected to the gate of the switching transistor of the other driver circuit, and wherein in each of the two driver circuits, an additional transistor is provided, connected between the gate of the driving transistor of the driver circuit in question and the select line associated with it, and is controlled on its gate by the select line associated with the other driver circuit, the order of the sequential selection of the select lines of the display screen being alternately reversed at each frame.

12. A display screen according to claim 8, wherein the addressing circuit comprises 2·m row select lines, two select lines per row of picture dots and n data lines, and to each picture element are made to correspond a respective data line connected to the switching transistors of the two associated driver circuits, and a first select line and a second select line, the first select line being connected to the gate of the switching transistor of one of the two driver circuits, the second select line being connected to the gate of the switching transistor of the other driver circuit, and wherein during one video frame, during the selection of the first select line, video voltages are applied to the columns whereas during the selection of the second select line, recovery voltages are applied to the columns, and during another video frame, the reverse occurs.

13. A display screen according to claim 9, each column of pixels having an associated first and second data line, further comprising a column driver capable of alternately delivering, at a first output connected to the first data line and at a second output connected to the second data line, a video voltage or a turn-off voltage being a function of the video voltage.

14. A display screen according to claim 8, wherein the addressing circuit comprises row and/or column drivers used in liquid crystal displays for controlling the select lines and/or data lines.

15. A display screen according to claim 10, each column of pixels having an associated first an second data line, further comprising a column driver configured to alternately deliver, at a first output connected to the first data line and at a second output connected to the second data line, a video voltage or a turn-off voltage being a function of the video voltage.
